(19) United States
(12) Patent Application Publication
(10) Pub. No.: US 2026/0245356 A1
(43) Pub. Date: Aug. 20, 2026

(54) MOBILE OBJECT CONTROL DEVICE, MOBILE OBJECT CONTROL METHOD, AND NON TRANSITORY STORAGE MEDIUM

(71) Applicant: HONDA MOTOR CO., LTD., Tokyo (JP)

(72) Inventor: Shotaro Odate, Tokyo (JP)

(21) Appl. No.: 19/461,788

(22) Filed: Jan. 28, 2026

(30) Foreign Application Priority Data
Feb. 17, 2025 (JP) 2025-023535

(51) Int. Cl. G06V 10/98; B60W 50/08; G06V 10/44; G06V 20/59; G06V 40/10

(52) U.S. Cl. CPC G06V 10/993; B60W 50/08; G06V 10/44; G06V 20/597; G06V 40/10; B60W 2720/106

(57) ABSTRACT

A control device acquires feature points of an occupant obtained from a detection result of a detection device configured to detect the occupant located in a mobile object, performs driver state determination for determining whether or not a driver of the mobile object is in a drivable state for the mobile object based on the feature points, determines that a detection area of the detection device is in a blocked state to prevent the driver state determination from being executed when an index based on the feature points is less than a threshold based on the feature points obtained from the detection result of the driver in the drivable state for the mobile object, and determines that the detection area is not in the blocked state to execute the driver state determination when the index is greater than or equal to the threshold.

### CROSS-REFERENCE TO RELATED APPLICATION

Priority is claimed on Japanese Patent Application No. 2025-023535, filed Feb. 17, 2025, the content of which is incorporated herein by reference.

### BACKGROUND

### Field of the Invention

The present invention relates to a mobile object control device, a mobile object control method, and a non-transitory storage medium.

### Description of Related Art

Recently, efforts to provide access to sustainable transportation systems have been increasingly active in consideration of vulnerable individuals among participants in transportation. For this realization, research and development (R&D) related to preventive safety technology related to driving assistance for assisting a driver in driving has focused on further improving traffic safety and convenience. For example, technology for determining whether or not a driver is in a drivable state for a vehicle from an image captured by imaging the driver driving the vehicle is known (PCT International Publication No. WO/2019/030855).

### SUMMARY

Meanwhile, a conventional driver state determination system may determine that a driver is not in a drivable state for a vehicle even though the driver is in the drivable state for the vehicle. For example, when a camera for capturing an image is blocked by a blocking object such as a towel or the driver’s hand, it may be determined that the driver is not in the drivable state for the vehicle. The conventional driver state determination system cannot appropriately determine a state in which blockage by a blocking object has occurred and a state in which the driver cannot drive the vehicle.

In order to solve the above problems, an objective of the present invention is to provide a mobile object control device, a mobile object control method, and a non-transitory storage medium that enable whether or not a detection area of a detection device has been blocked to be appropriately determined. More specifically, another objective of the present invention is to prevent a process of determining that a driver is not in a drivable state for a vehicle when there is a blocking object that blocks a detection area of a detection device. Also, the present invention contributes to the development of sustainable transportation systems.

A mobile object control device, a mobile object control method, and a non-transitory storage medium according to the present invention adopt the following configurations.
(1): According to an aspect of the present invention, there is provided a mobile object control device including: a non-transitory storage medium storing computer-readable instructions; and one or more processors connected to the non-transitory storage medium, the processor executing the computer-readable instructions to: acquire feature points of an occupant obtained from a detection result of a detection device configured to detect the occupant located in a mobile object; determine that a detection area of the detection device is in a blocked state to prevent driver state determination using the detection result indicating that the detection area is in the blocked state from being executed when an index based on the feature points is less than a threshold set in advance based on the feature points obtained from the detection result of the driver in the drivable state for the mobile object; and determine that the detection area is not in the blocked state to execute the driver state determination using the detection result indicating that the detection area is not in the blocked state when the index based on the feature points is greater than or equal to the threshold set in advance, wherein the driver state determination for determining whether or not a driver of the mobile object is in a drivable state for the mobile object based on the feature points.
(2): In the above-described aspect (1), the processor executes the computer-readable instructions to determine a direction in which a blocking object for blocking the detection area appears based on the feature points and change the threshold in accordance with the direction.
(3): In the above-described aspect (2), the processor executes the computer-readable instructions to: determine the blocked state by comparing the index based on the feature points with a first threshold when it is determined that the detection area is in the blocked state by the blocking object appearing from a direction of a driver seat of the mobile object; and determine the blocked state by comparing the index based on the feature points with a second threshold less than the first threshold when it is determined that the detection area is in the blocked state by the blocking object appearing from a direction of a passenger seat of the mobile object.
(4): In the above-described aspect (2), the processor executes the computer-readable instructions to determine the blocked state by comparing the index with the threshold, wherein the index is a cumulative quantity of the feature points.
(5): In the above-described aspect (2), the processor executes the computer-readable instructions to determine that the detection area is in the blocked state when a state in which the index based on the feature points is less than the threshold set in advance continues for a set time or more.
(6): In the above-described aspect (5), the processor executes the computer-readable instructions to: set the set time to a first set time when it is determined that the detection area is in the blocked state by the blocking object appearing from a direction of a driver seat of the mobile object, and set the set time to a second set time longer than the first set time when it is determined that the detection area is in the blocked state by the blocking object appearing from a direction of a passenger seat of the mobile object.
(7): In the above-described aspect (1), the detection device is provided in a navigation device of the mobile object or near the navigation device, and the processor executes the computer-readable instructions to prevent the determination of the blocked state or the driver state determination from being performed in a state in which an operation on the navigation device of the mobile object has been detected.
(8): In the above-described aspect (1), the processor executes the computer-readable instructions to decelerate or stop the mobile object when it is determined that the driver of the mobile object is not in the drivable state as determined in the driver state determination.
(9): According to an aspect of the present invention, there is provided a mobile object control method including: acquiring, by a computer, feature points of an occupant obtained from a detection result of a detection device configured to detect the occupant located in a mobile object; determining, by the computer, that a detection area of the detection device is in a blocked state to prevent driver state determination using the detection result indicating that the detection area is in the blocked state from being executed when an index based on the feature points is less than a threshold set in advance based on the feature points obtained from the detection result of the driver in the drivable state for the mobile object; and determining, by the computer, that the detection area is not in the blocked state to execute the driver state determination using the detection result indicating that the detection area is not in the blocked state when the index based on the feature points is greater than or equal to the threshold set in advance, wherein the driver state determination for determining whether or not a driver of the mobile object is in a drivable state for the mobile object based on the feature points .
(10): According to an aspect of the present invention, there is provided a non-transitory storage medium storing a program for causing a computer to execute: a process for acquiring feature points of an occupant obtained from a detection result of a detection device configured to detect the occupant located in a mobile object; a process for determining that a detection area of the detection device is in a blocked state to prevent driver state determination using the detection result indicating that the detection area is in the blocked state from being executed when an index based on the feature points is less than a threshold set in advance based on the feature points obtained from the detection result of the driver in the drivable state for the mobile object; and a process for determining that the detection area is not in the blocked state to execute the driver state determination using the detection result indicating that the detection area is not in the blocked state when the index based on the feature points is greater than or equal to the threshold set in advance, wherein the driver state determination for determining whether or not a driver of the mobile object is in a drivable state for the mobile object based on the feature points.

According to the above-described aspects (1) to (10), the mobile object control device, the mobile object control method, or the non-transitory storage medium enables a process for appropriately determining whether or not the detection area of the detection device is in the blocked state by performing the determination based on the index and threshold based on the feature points.

According to the above-described aspect (2), it is possible to improve the accuracy of determining whether or not the detection area of the detection device is in the blocked state by changing the threshold according to the direction in which the blocking object appears.

According to the above-described aspect (3), by setting the second threshold to a value less than the first threshold, it is possible to perform careful determination when the blocking object appears from a direction in which a possibility of blocking is low and it is possible to increase the accuracy of determining whether or not the detection area of the detection device is in the blocked state.

According to the above-described aspect (4), it is possible to appropriately determine whether or not the detection area of the detection device is in the blocked state by performing the determination based on the cumulative quantity of the feature points.

According to the above-described aspect (5), it is possible to improve the accuracy of determining whether or not the detection area of the detection device is in the blocked state by performing the determinations based on the duration of the state in which the index is less than the threshold.

According to the above-described aspect (6), it is possible to improve the accuracy of determining whether or not the detection area of the detection device is in the blocked state by setting the second set time to a value greater than the first set time. When the blocking object appears from the direction of the passenger seat, the second set time, which is longer than that when the blocking object appears from the driver seat, is set as the set time, and the body of the occupant of the passenger seat blocks the detection area, so that it is possible to suppress a process in which the driver state determination can be easily performed. For example, the occupant of the passenger seat may operate the navigation device, for example, for the first set time or more. In this case, the process in which the driver state determination can be easily performed is suppressed.

According to the above-described aspect (7), when the operation on the navigation device is detected, it is possible to appropriately determine whether or not the detection area of the detection device is in the blocked state by determining that the detection area is not in the blocked state or preventing the driver state determination from being performed. Specifically, even if the index is not less than the threshold, when the operation on the navigation device is detected, because a possibility that there will be a blocking object such as a hand for the operation is significantly high, it is determined that the detection area is in the blocked state or the driver state determination is not performed.

According to the above-described aspect (8), when it is determined that the driver is not in the drivable state for the mobile object in the driver state determination, the mobile object can be appropriately controlled by decelerating or stopping the mobile object.

### BRIEF DESCRIPTION OF THE DRAWINGS

FIG. 1 is a configuration diagram of a vehicle system using a vehicle control system according to an embodiment.

FIG. 2 is a diagram showing a state within a vehicle cabin according to an embodiment.

FIG. 3 is an enlarged diagram of an operation area.

FIG. 4 is a diagram showing an example of image information about an image captured by an in-cabin camera.

FIG. 5 is a diagram showing an example of image information about an image captured by the in-cabin camera.

FIG. 6 is a flowchart showing an example of a flow of a process executed by a driving assistance device.

FIG. 7 is a diagram showing an example of image information about an image captured by the in-cabin camera.

FIG. 8 is a flowchart showing an example of a flow of a process executed by the driving assistance device.

FIG. 9 is a diagram showing a period of time required for each operation of the navigation device.

FIG. 10 is a flowchart showing an example of a flow of a process executed by the driving assistance device.

### DETAILED DESCRIPTION OF THE INVENTION

### Overall configuration

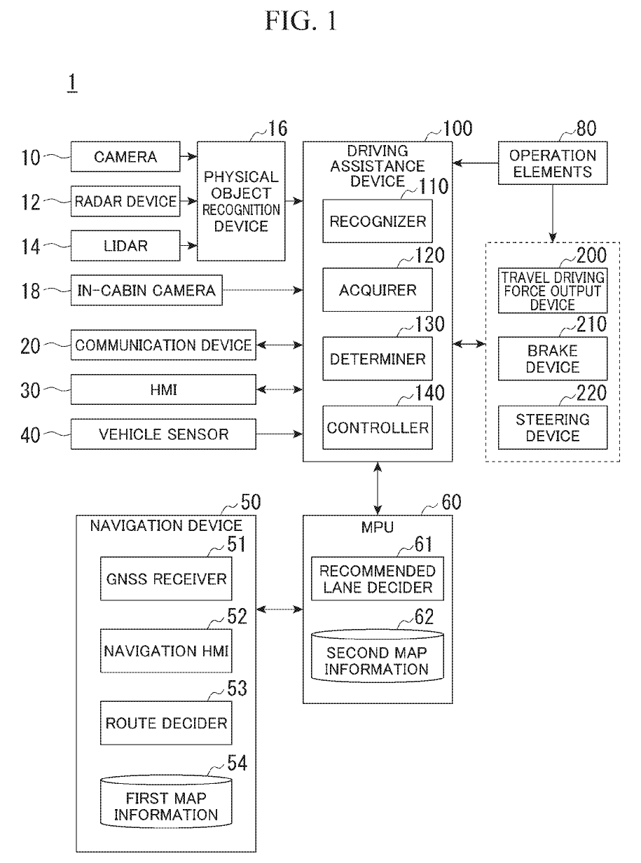

FIG. 1 is a configuration diagram of a vehicle system 1 using a vehicle control system according to an embodiment. A vehicle on which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power when a secondary battery or a fuel cell is discharged. Although the case where the present embodiment is applied to a vehicle will be described, the present invention may be applied to other mobile objects instead of a vehicle.

For example, the vehicle system 1 includes a camera 10, a radar device 12, a light detection and ranging (LIDAR) 14, a physical object recognition device 16, an in-cabin camera 18, a communication device 20, a human machine interface (HMI) 30, a vehicle sensor 40, a navigation device 50, a map positioning unit (MPU) 60, operation elements 80, a driving assistance device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and some of the constituent elements may be omitted or other constituent elements may be further added. The driving assistance device 100 is an example of a “mobile object control device.”

For example, the camera 10 is a digital camera using a solid-state imaging element such as a charge-coupled device (CCD) or a complementary metal oxide semiconductor (CMOS). The camera 10 is attached to any location on a vehicle (hereinafter, a vehicle M) where the vehicle system 1 is mounted. When the view in front of the vehicle M is imaged, the camera 10 is attached to an upper part of a front windshield, a rear surface of a rearview mirror, or the like. For example, the camera 10 periodically and iteratively images the surroundings of the vehicle M. The camera 10 may be a stereo camera.

The radar device 12 radiates radio waves such as millimeter waves around the vehicle M and detects at least a position of a physical object (a distance from the physical object and a direction of the physical object) by detecting radio waves (reflected waves) reflected by the physical object. The radar device 12 is attached to any location on the vehicle M. The radar device 12 may detect a position and a speed of the physical object in a frequency-modulated continuous wave (FM-CW) scheme.

The LIDAR 14 radiates light (or electromagnetic waves having a wavelength close to that of light) around the vehicle M and measures scattered light. The LIDAR 14 detects a distance from a target based on a period of time from light emission to light reception. The radiated light is, for example, pulsed laser light. The LIDAR 14 is attached to any location of the vehicle M.

The physical object recognition device 16 performs a sensor fusion process on detection results from some or all of the camera 10, the radar device 12, and the LIDAR 14 to recognize a position, type, speed, and the like of the physical object. The physical object recognition device 16 outputs a recognition result to the driving assistance device 100. The physical object recognition device 16 may output detection results of the camera 10, the radar device 12, and the LIDAR 14 to the driving assistance device 100 as they are. The physical object recognition device 16 may be omitted from the vehicle system 1.

The in-cabin camera 18 is, for example, a digital camera that uses a solid-state imaging element such as a CCD or CMOS. The in-cabin camera 18 is mounted at a position and orientation for capturing an image of the face of a driver of the vehicle M. For example, the in-cabin camera 18 is attached near the HMI 30 or the navigation HMI 52 (the display of the navigation device 50) or the like. The in-cabin camera 18 may be mounted on any location in the vehicle M if the above-described conditions are satisfied. The in-cabin camera 18 generates image information about an image captured by imaging scenery inside the vehicle. The image information about the captured image includes the face of the driver. The image information may also include the state of an occupant (passenger) sitting in a seat other than a driver seat of the vehicle M. The in-cabin camera 18 transmits the generated image information to the driving assistance device 100. The in-cabin camera 18 is an example of a “detection device.” A detection device capable of detecting a situation inside the vehicle cabin may be provided instead of (or in addition to) the in-cabin camera 18. For example, a device capable of detecting the situation inside the vehicle cabin by an optical method may be provided, and an index obtained from the detection result of this detection device may be used in a process to be described below.

The communication device 20, for example, communicates with another vehicle located in the vicinity of the vehicle M using a cellular network, a Wi-Fi network, Bluetooth (registered trademark), dedicated short-range communication (DSRC), or the like or communicates with various types of server devices via a radio base station.

The HMI 30 presents various types of information to an occupant of the vehicle M and receives an input operation from the occupant. The HMI 30 includes various types of display devices, a speaker, a buzzer, a touch panel, a switch, keys, and the like. The HMI 30 includes a display device. The display device is provided on an instrument panel of the vehicle M and is, for example, a display device, i.e., a multi-information display, configured to display various information in the vehicle M such as a speedometer indicating a traveling speed of the vehicle M or a tachometer indicating the number of rotations (a rotational speed) of the internal combustion engine provided in the vehicle M.

The vehicle sensor 40 includes a vehicle speed sensor configured to detect the speed of the vehicle M, an acceleration sensor configured to detect acceleration, a yaw rate sensor configured to detect angular velocity around a vertical axis, a direction sensor configured to detect a direction of the vehicle M, a sensor configured to detect a rotation angle of steering, and the like.

For example, the navigation device 50 includes a global navigation satellite system (GNSS) receiver 51, a navigation HMI 52, and a route decider 53. The navigation device 50 holds first map information 54 in a storage device such as a hard disk drive (HDD) or a flash memory. The GNSS receiver 51 identifies a position of the vehicle M based on a signal received from a GNSS satellite. The position of the vehicle M may be identified or complemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route decider 53 decides a route (hereinafter referred to as a route on a map) from the position of the vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include curvature of a road, point of interest (POI) information, and the like. The route on the map is output to the MPU 60. The navigation device 50 may provide route guidance using the navigation HMI 52 based on the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

The MPU 60 includes, for example, a recommended lane decider 61, and holds second map information 62 in a storage device such as an HDD or a flash memory. The recommended lane decider 61 divides the route on the map provided from the navigation device 50 into a plurality of blocks (e.g., divides the route every 100 [m] in a travel direction of the vehicle), and decides a recommended lane for each block with reference to the second map information 62. The recommended lane decider 61 decides in what lane numbered from the left the vehicle will travel. The recommended lane decider 61 decides the recommended lane so that the vehicle M can travel along a reasonable route for traveling to a branching destination when there is a branch point on the route on the map. For example, when the vehicle M reaches a position that is a predetermined distance before a branch path that the vehicle M is scheduled to enter, the recommended lane decider 61 decides a lane connecting to the branch path as the recommended lane. The recommended lane decider 61 and the second map information 62 may be a functional unit or information included in another device such as the driving assistance device 100. Information about the recommended lane, for example, is provided to the driver via the HMI.

The second map information 62 is map information with higher accuracy than the first map information 54. The second map information 62 includes, for example, information about a center of a lane, information about a boundary of the lane, or the like. The second map information 62 may include road information, traffic regulation information, address information (address/postal code), facility information, telephone number information, and the like. The second map information 62 may be updated at any time by the communication device 20 communicating with other devices.

The operation elements 80 include, for example, a steering wheel, an accelerator pedal, a brake pedal, a shift lever, and other operation elements. A sensor for detecting an amount of operation or the presence or absence of an operation is attached to the operation element 80 and a detection result thereof is output to the driving assistance device 100 or some or all of the travel driving force output device 200, the brake device 210, and the steering device 220. The steering wheel does not necessarily have to be annular and may be in the form of a variant steering wheel, a joystick, a button, or the like.

The driving assistance device 100 includes, for example, a recognizer 110, an acquirer 120, a determiner 130, and a controller 140. The recognizer 110, the acquirer 120, the determiner 130, and the controller 140 are implemented, for example, by a hardware processor such as a central processing unit (CPU) executing a program (software). Some or all of the above constituent elements may be implemented by hardware (including a circuit; circuitry) such as a large-scale integration (LSI) circuit, an application-specific integrated circuit (ASIC), a field-programmable gate array (FPGA), a graphics processing unit (GPU), or a system on chip (SOC) or may be implemented by software and hardware in cooperation. The program may be pre-stored in the storage (a storage device including a non-transitory storage medium) such as an HDD or a flash memory in the driving assistance device 100 or may be stored in a removable storage medium such as a DVD or a CD-ROM and installed in an HDD or a flash memory of the driving assistance device 100 when the storage medium (the non-transitory storage medium) is mounted in a drive device.

On the basis of surroundings information input from the camera 10, the radar device 12, and the LIDAR 14 via the physical object recognition device 16, the recognizer 110 recognizes a state of a position, velocity, acceleration, or the like of a physical object in the vicinity of the vehicle M. The position of the physical object, for example, is recognized as a position of an absolute coordinate system having a representative point of the vehicle M (a center of gravity, a drive shaft center, or the like) as the origin, and is used for control. The position of the physical object may be represented by a representative point such as the center of gravity or a corner of the physical object or may be represented by an area. The “state” of the physical object may include the acceleration or jerk of the physical object, or the “action state” (e.g., whether or not the vehicle is changing lanes or is about to change lanes).

The recognizer 110 recognizes, for example, a travel path of the vehicle M, a travel path located in another nearby area, and the like. The travel path is a path on a road including a lane in which the vehicle M travels (a travel lane), an oncoming lane opposite to the travel lane, or the like. For example, the recognizer 110 recognizes the travel path by comparing a pattern of road markings (e.g., an arrangement of solid lines SL and broken lines) obtained from the second map information 62 with a pattern of road markings in the vicinity of the vehicle M recognized from an image captured by the camera 10. The recognizer 110 may recognize a travel path by recognizing a travel path boundary (a road boundary) including a road marking, a road shoulder, a curb, a median strip, a guardrail, and the like as well as a road marking. In this recognition, a position of the vehicle M acquired from the navigation device 50 or a processing result of the INS may be taken into account. The recognizer 110 recognizes a temporary stop line, an obstacle, a red traffic light, and a toll gate located near the vehicle M, and other road events.

The recognizer 110 recognizes a behavior of the vehicle M on the basis of a detection result of the vehicle sensor 40. For example, when the travel path is recognized, the recognizer 110 recognizes a position or posture of the vehicle M with respect to the travel path. For example, the recognizer 110 may recognize a deviation of a reference point of the vehicle M from the center of the lane and an angle formed between the travel direction of the vehicle M and a line connected to the center of the lane as a relative position and posture of the vehicle M related to the travel path. Alternatively, the recognizer 110 may recognize the position of the reference point of the vehicle M for any side end of the travel path (the road marking or the road boundary) or the like as a position of the vehicle M relative to the travel path.

The acquirer 120 acquires a feature point of the occupant of the vehicle M based on the image information obtained from the in-cabin camera 18 (an example of a “detection result”). The image information is information about the scenery in the vehicle and includes information about the occupant of the vehicle M. The feature point is an outline of parts such as the eyes and mouth of the occupant of the vehicle M, a boundary of the occupant of the vehicle M, or the like.

The determiner 130 executes driver state determination based on the feature points. The driver state determination is a process for determining whether or not the driver of the vehicle M is in a drivable state for the vehicle M. The determiner 130 derives the driver’s information such as the driver’s posture, facial expression, gaze information, and the like based on a positional relationship of a plurality of feature points in the driver’s outline, and executes the driver state determination based on the driver’s information. The driver state determination is a process for determining whether or not the driver has an abnormality due to a posture in a state that is not suitable for driving when the vehicle M travels. For example, when the driver’s posture is tilted significantly forward or sideways or when a state in which the driving posture is significantly unstable continues for a target time or more, it is estimated that there is an abnormality in the driver.

The controller 140 controls the entire configuration contained in the driving assistance device 100 and the vehicle system 1. The controller 140, for example, controls the steering of the vehicle M, controls the speed of the vehicle M, and controls the HMI 30 so that the HMI 30 provides information to the driver. The controller 140 outputs an alert or decelerates or stops the vehicle M where there is an abnormality in the driver. Details of the processes of the determiner 130 and the controller 140 will be described below.

The travel driving force output device 200 outputs a travel driving force (torque) for enabling the traveling of the vehicle to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described constituent elements in accordance with information input from the driving assistance device 100 or information input from the operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the driving assistance device 100 or the information input from the operation element 80 so that brake torque according to a braking operation is output to each wheel.

For example, the steering device 220 includes a steering ECU and an electric motor. For example, the electric motor changes directions of steerable wheels by applying a force to a rack and pinion mechanism. The steering ECU drives the electric motor in accordance with the information input from the driving assistance device 100 or the information input from the operation element 80 to change the directions of the steerable wheels.

### Overview

The present embodiment implements control for providing driving assistance when the driver of the vehicle M is not in a drivable state for the vehicle M and ensuring the safety of occupants and surroundings of the vehicle M. For example, while the vehicle M is traveling, the driving assistance device 100 supports safe driving by outputting an alert or decelerating or stopping the vehicle M when the driver’s posture is significantly tilted forward or sideways (when the posture is not suitable for driving and it is estimated that there is an abnormality in the driver). In the present embodiment, based on the information about the feature point acquired by the acquirer 120, the determiner 130 decides whether or not to perform the driver state determination.

### Details of process

In the present embodiment, it is decided whether or not to perform the driver state determination based on the feature points. The determiner 130 compares an index based on the feature points acquired by the acquirer 120 with the threshold and decides whether or not to perform the driver state determination.

The acquirer 120 acquires a plurality of feature points of the occupant of the vehicle M included in image information about of an image of the cabin of the vehicle M captured by the in-cabin camera 18 based on the image information.

The determiner 130 compares an index, which is a cumulative quantity of feature points, with a threshold. It is only necessary for the threshold to be a value set in advance based on the feature points obtained from the image information including the driver who is in a drivable state for the vehicle M. For example, the driver is a driver who is an experiment or simulation target or the like for setting the threshold instead of a driver serving as a determination target of the driving assistance device 100. The index is not limited to a cumulative value, and may be an index obtained by statistically processing a cumulative quantity or an index obtained by performing a prescribed process on the feature point.

The determiner 130 determines that the state is not the blocked state when the index is greater than or equal to the threshold and determines that the state is the blocked state when the index is less than the threshold. The blocked state is a state in which at least a part of a detection area of the in-cabin camera 18 has been blocked. When it is determined that the detection area is in the blocked state, image information about an image captured by the in-cabin camera 18 includes a blocking object.

The determiner 130 does not perform the driver state determination when it is determined that the detection area is in the blocked state, and performs the driver state determination when the detection area is not in the blocked state.

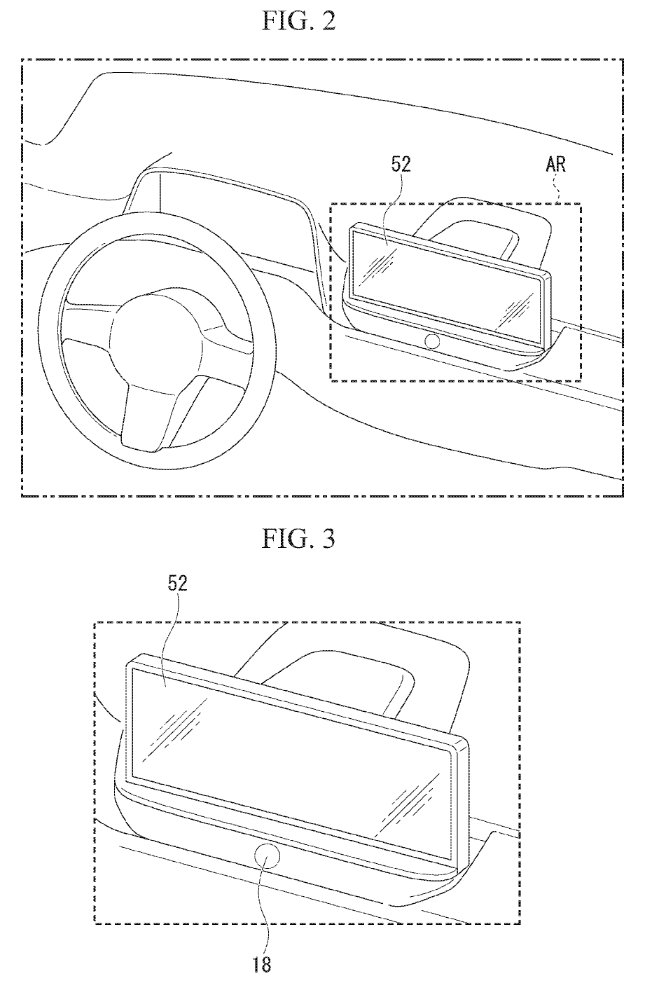

FIG. 2 is a diagram showing a state of the vehicle cabin according to the embodiment. When the navigation HMI 52 of the navigation device or the like is operated, the occupant of the vehicle M performs an operation within an operation area AR (e.g., a touch panel of the display). The operation within the operation area AR, for example, is performed by a driver D sitting in a driver seat, an occupant sitting in a passenger seat, or the like.

FIG. 3 is an enlarged diagram of the operation area AR. As shown in FIG. 3, the in-cabin camera 18 is located around the navigation HMI 52 (the center of the navigation HMI 52 in the width direction or the vertical direction near the center in FIG. 3). For this reason, the image captured by the in-cabin camera 18 may include a hand, an arm, or the like of the occupant performing an operation on the navigation HMI 52 or the surrounding area of the navigation HMI 52 when the occupant of the vehicle M performs an operation on the navigation HMI 52 or the surrounding area of the navigation HMI 52.

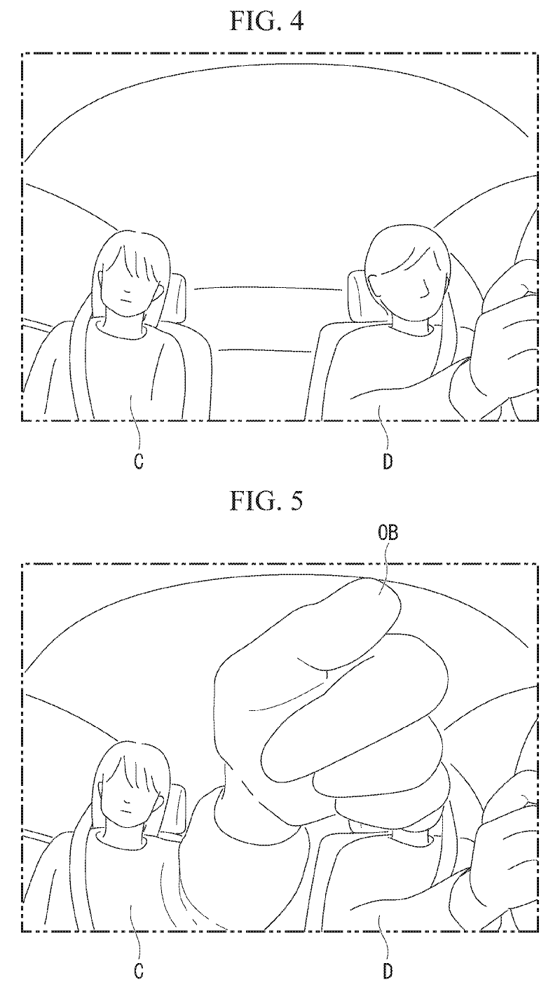

FIG. 4 is a diagram showing an example of image information about an image captured by the in-cabin camera 18. The scene shown in FIG. 4 is a state in which the occupant of the vehicle M is not performing an operation on the navigation HMI 52 or the surrounding area of the navigation HMI 52.

The acquirer 120 acquires feature points from the image information in FIG. 4. FIG. 4 does not include a blocking object in the image information, but includes a state in which the driver D is driving the vehicle M and a state in which an occupant C is sitting in the passenger seat. At this time, a cumulative quantity of the feature points in the image information in FIG. 4 is greater than or equal to a threshold. In the image information in FIG. 4, the cumulative quantity of the feature points is greater than or equal to the threshold according to faces and facial parts of the driver and occupant of the image information. The determiner 130 determines that the scene of FIG. 4 is not in the blocked state because the cumulative quantity of the feature points is greater than or equal to the threshold, and executes the driver state determination.

FIG. 5 is a diagram showing an example of the image information about an image captured by the in-cabin camera 18. The scene shown in FIG. 5 shows a state in which an occupant (occupant C) sitting in the passenger seat of the vehicle M is operating the navigation HMI 52.

The acquirer 120 acquires feature points from the image information in FIG. 5. FIG. 5 includes a hand (blocking object OB) of the occupant C. A face of a driver D is blocked by the blocking object OB. In FIG. 5, because the face of the driver D, which is formed from a large number of feature points, is blocked, a cumulative quantity of the feature points is less than that when there is no blocking object OB. At this time, the determiner 130 determines that the scene in FIG. 5 is in the blocked state because the cumulative quantity of the feature points is less than the threshold, and does not execute the driver state determination.

Although an example in which the occupant of the passenger seat is included in the image has been described in the above-described example, the occupant of the passenger seat may not be imaged and the image in which only the driver is imaged may be a processing target image.

### Flowchart 1

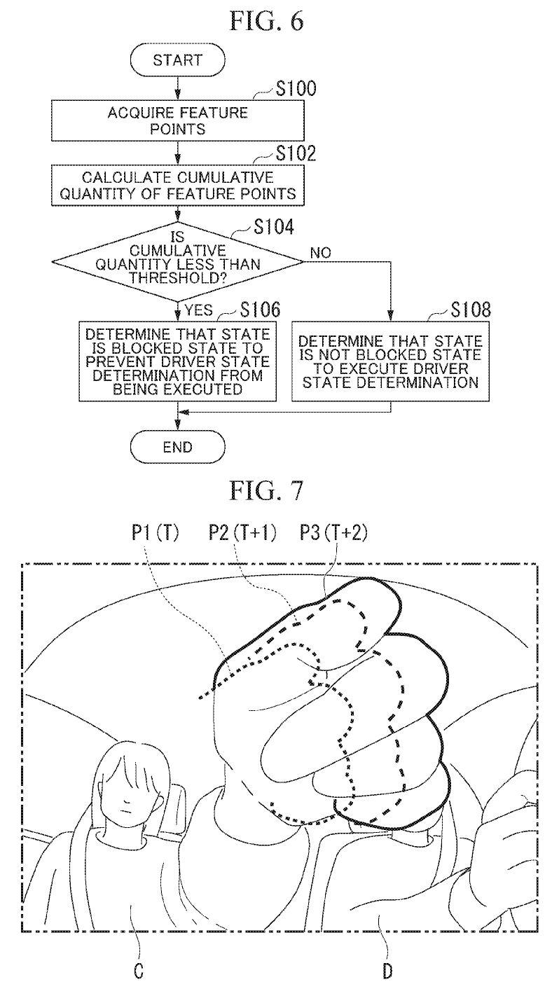

FIG. 6 is a flowchart showing an example of a flow of a process executed by the driving assistance device 100. The flowchart shown in FIG. 6 is executed, for example, when the vehicle M is traveling.

First, the acquirer 120 acquires feature points from information of an image captured by the in-cabin camera 18 (step S100). Subsequently, the determiner 130 calculates a cumulative quantity of the feature points (step S102). Subsequently, the determiner 130 determines whether the cumulative quantity of the feature points is less than a threshold (step S104).

When it is determined that the cumulative quantity of the feature points is less than the threshold, the determiner 130 determines that the state is the blocked state to prevent the driver state determination from being performed (step S106). When it is determined that the cumulative quantity of the feature points is not less than the threshold, i.e., the cumulative quantity of the feature points is greater than or equal to the threshold, the determiner 130 determines that the state is not the blocked state to perform the driver state determination (step S108). Thereby, the process of the present flowchart ends.

As described above, the determiner 130 can appropriately determine whether or not the detection area of the detection device is in the blocked state by performing the determination based on the cumulative quantity of the feature points and the threshold. For example, when the image information includes the hand of the occupant operating the navigation HMI 52 as the blocking object, the cumulative quantity of the acquired feature points is less than that when the blocking object is not included in the image information, because the hand that is the blocking object is included in the image information. Therefore, the determiner 130 can appropriately determine the case of the blocked state in which there is a blocking object by comparing the cumulative quantity of the feature points with the threshold. Because there is a possibility that the state of the driver cannot be appropriately determined in the case of the blocked state, the determiner 130 does not perform the driver state determination whose accuracy is low by deciding that the driver state determination based on the feature points will not be executed. Specifically, if the driver state determination is performed in the case of the blocked state in which the index of the feature points is less than the threshold, it is determined that there is an abnormality in the driver. For example, when the driver’s body or head is tilted forward or backward, the index of the feature points is less than the threshold and the index of the feature points will be an index of feature points with a tendency similar to that of the blocked state in which blockage by the blocking object has occurred. In the present embodiment, in the consideration of the above-described situation, the index of the feature points and the threshold are compared to appropriately determine the blocked state.

### Change in threshold

The threshold may be changed with a direction in which the blocking object appears. The determiner 130 calculates the direction in which the blocking object appears based on a change over time in the feature point of the blocking object. Directions in which the feature points appear are two directions that are a direction of the driver seat and a direction of the passenger seat. The determiner 130 sets the threshold to a first threshold when the blocking object appears from the direction of the driver seat, and sets the threshold to a second threshold when the blocking object appears from the direction of the passenger seat. The second threshold is a value that is less than the first threshold.

FIG. 7 is a diagram showing an example of image information about an image captured by the in-cabin camera 18. The image in FIG. 7 is an image of a face of a driver D hidden by his or her hand because the occupant C of the passenger seat is operating the navigation HMI 52 as in FIG. 5. Feature points P1 are a plurality of feature points provided in a blocking object OB (a hand of the occupant of the passenger seat) at time T. Feature points P2 are a plurality of feature points of the blocking object OB at time T+1. Feature points P3 are a plurality of feature points of the blocking object OB at time T+2.

In the scene shown in FIG. 7, the determiner 130 determines that the plurality of feature points provided in the blocking object OB have moved from the passenger seat side to the navigation HMI 52 side in accordance with the elapse of time, in the order of the feature points P1, the feature points P2, and the feature points P3. In other words, the determiner 130 determines that the direction in which the blocking object OB appears is the direction of the passenger seat. The determiner 130 may determine the direction in which the blocking object OB appears based on changes over time in the plurality of feature points provided in the blocking object OB, or may determine the direction in which the blocking object OB appears based on a change over time in one feature point of a target of interest decided by the determiner 130 among the plurality of feature points provided in the blocking object OB.

### Flowchart 2

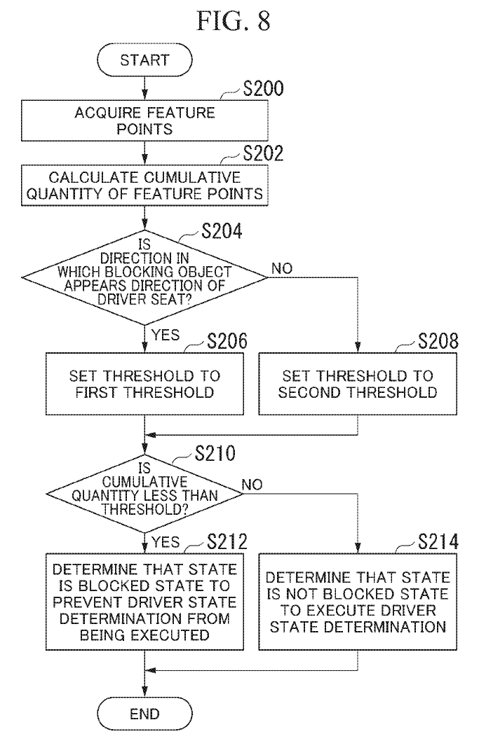

FIG. 8 is a flowchart showing an example of a flow of a process executed by the driving assistance device 100. The flowchart shown in FIG. 8 is executed, for example, when the vehicle M is traveling.

First, the acquirer 120 acquires feature points from image information about an image captured by the in-cabin camera 18 (step S200). Subsequently, the determiner 130 calculates a cumulative quantity of the feature points (step S202). Subsequently, the determiner 130 determines whether or not the direction in which the blocking object appears is a direction of the driver seat (step S204).

The determiner 130 sets the threshold to the first threshold when it is determined that the direction in which the blocking object appears is a direction of the driver seat (step S206). The determiner 130 sets the threshold to the second threshold when it is determined that the direction in which the blocking object appears is not the direction of the driver seat, i.e., when it is determined that the direction in which the blocking object appears is the direction of the passenger seat (step S208).

The determiner 130 determines whether or not a cumulative quantity of the feature points is less than the threshold (step S210). The above-described threshold is the first or second threshold decided in accordance with the determination process of step S204. When it is determined that the cumulative quantity of the feature points is less than the threshold, the determiner 130 determines that the state is the blocked state to prevent the driver state determination from being performed (step S212). When it is determined that the cumulative quantity of the feature points is not less than the threshold, i.e., the cumulative quantity of the feature points is greater than or equal to the threshold, the determiner 130 determines that the state is not the blocked state to perform the driver state determination (step S214). Thereby, the process of the present flowchart ends.

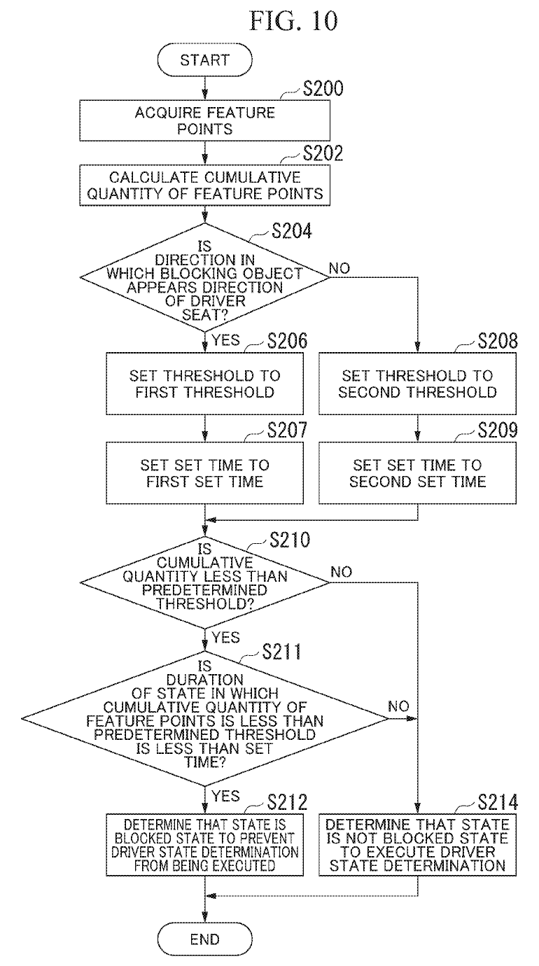

The above-described processing order may be changed. For example, the processing of step S202 may be executed after the processing of step S206 or step S208. The same is true for the flowchart of FIG. 10, which will be described below.

As described above, the determiner 130 can improve the accuracy of determining whether or not the detection area of the detection device is in the blocked state by changing the threshold based on the direction in which the blocking object appears. For example, when the blocking object appears from the direction of the passenger seat, a threshold smaller than that when the blocking object appears from the driver seat side is used to determine whether or not the detection area is in the blocked state. Thereby, the determiner 130 can perform careful determination when the blocking object appears from a direction in which a possibility of blocking is low (in the direction of the passenger seat), thereby improving the accuracy of determining whether or not the detection area is in the blocked state.

### Determination using set time

When the index is less than the predetermined threshold, the determiner 130 may determine that the state is not the blocked state when it is determined that a state in which the index is less than the predetermined threshold continues for the set time or more and determine that the state is the blocked state when the state in which the index is less than the predetermined threshold does not continue for the set time or more. The predetermined threshold may be a value similar to the above-described threshold, the first threshold, or the second threshold, or may be a value larger than the above-described value.

The set time is a preset time based on, for example, the time required for an occupant to operate the navigation HMI 52 or its surrounding area. The set time may be changed with the direction in which the blocking object appears. The determiner 130 sets the set time to a first set time when the blocking object appears from a driver seat direction, and sets the set time to a second set time when the blocking object appears from the passenger seat direction. The second set time is a period of time longer than the first set time.

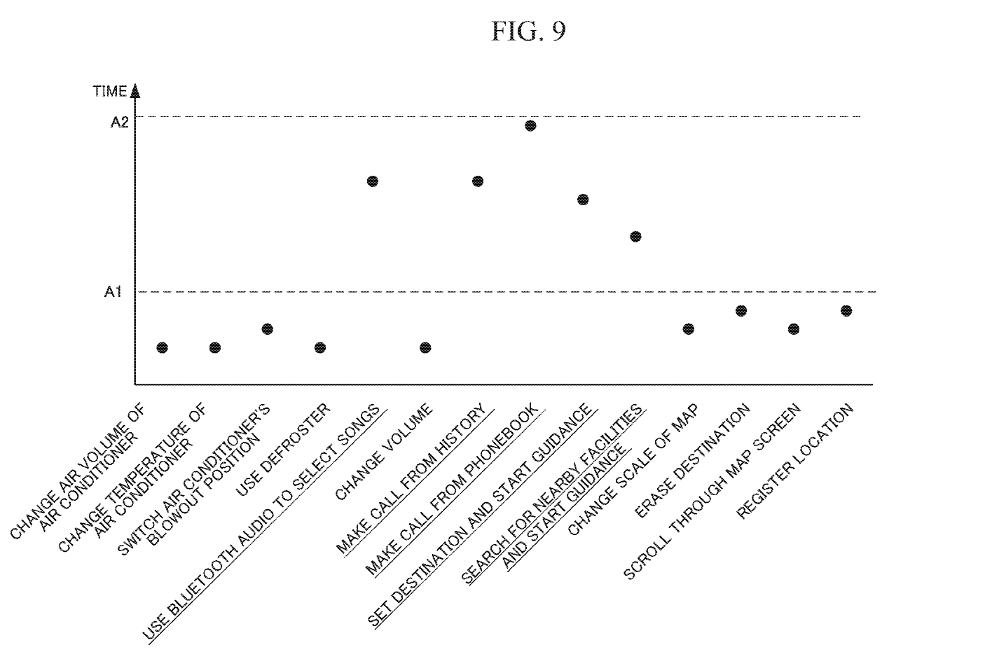

FIG. 9 is a diagram showing a period of time required for each operation of the navigation device. In FIG. 9, the vertical axis represents required time and the horizontal axis represents a type of operation. The horizontal axis represents a main operation performed on the navigation HMI 52 or its surrounding area. Among the operations indicated on the horizontal axis, five types of operations indicated in the underline, i.e., “Use Bluetooth audio to select songs,” “Make call from history,” “Make call from phone book,” “Set destination and start guidance,” and “Search for nearby facilities and start guidance” are operations that are likely to be performed by the occupant sitting in the passenger seat (hereinafter referred to as the occupant) or operations that are performed frequently by the driver (second operations) and other operations are operations that are likely to be performed by the driver or operations that are performed frequently by the driver (first operations). Comparing the times required for the operations, it can be seen that the time required for the second operation is longer than the time required for the first operation. Therefore, a second set time A2 is set to a period of time longer than a first set time A1. The first set time A1 is, for example, the first operation time of the first operation or the time obtained by adding a margin time to the first operation time. The first operation time is the time obtained by statistically processing the time when the first operation is performed. The second set time A2 is, for example, the second operation time of the second operation or the time obtained by adding a margin time to the second operation time. The second operation time is the time obtained by statistical processing of the time when the second operation is performed.

As described above, it is possible to improve the accuracy of determining whether or not blockage by a blocking object has occurred by determining whether or not the state is the blocked state based on the duration of a state in which the index is less than the predetermined threshold. For example, when the driver has performed an operation for scrolling through a map screen on the navigation HMI 52 (when the blocking object appears from the driver seat direction), if the duration of the state in which the index is less than the predetermined threshold is less than the first set time A1, the determiner 130 determines that the state is the blocked state to prevent the driver state determination from being performed. In this case, the blocked state is estimated to be caused by the driver’s operation on the navigation HMI 52 instead of the driver’s abnormality. For example, when the occupant of the passenger seat has performed an operation for searching for a nearby facility and starting guidance on the navigation HMI 52 (when a blocking object appears from the passenger seat direction), if the duration of the state in which the index is less than the predetermined threshold is less than the second set time A2, the determiner 130 determines that the state is the blocked state to prevent the driver state determination from being performed. In this case, the blocked state is estimated to be caused by an operation of the occupant of the passenger seat on the navigation HMI 52 instead of the driver’s abnormality.

### Flowchart 3

FIG. 10 is a flowchart showing an example of a flow of a process executed by the driving assistance device 100. A process different from the process of the flowchart in FIG. 8 will be mainly described.

Description of the processing of steps S200 to S206, S208, and S210 to S214 is similar to that in Flowchart 2 of FIG. 8 described above.

When it is determined that the direction in which the blocking object appears is the direction of the driver seat in the processing of step S204, the determiner 130 sets the threshold to the first threshold (step S206) and sets the set time to the first set time (step S207). When it is determined that the direction in which the blocking object appears is not the direction of the driver seat in the processing of step S204, the determiner 130 sets the threshold to the second threshold (step S208) and sets the set time to the second set time (step S209). Subsequently, the determiner 130 determines whether or not the cumulative quantity of the feature points is less than the threshold (step S210).

When it is determined that the cumulative quantity of the feature points is less than a predetermined threshold, the determiner 130 determines whether or not the duration of the state in which the cumulative quantity of the feature points is less than the predetermined threshold is less than the set time (step S211). When it is determined that the blocked state continues for less than the set time, the determiner 130 determines that the state is the blocked state to prevent the driver state determination from being performed.

When it is determined that the cumulative quantity of the feature points is not less than the threshold in the processing of step S210 or when it is determined that the blocked state does not continue for less than the set time in the processing of step S211, the determiner 130 determines that the state is not the blocked state and performs the driver state determination. Thereby, the process of the present flowchart ends.

As described above, the determiner 130 can improve the accuracy of determining whether or not blockage by the blocking object has occurred by changing the threshold and the set time based on the direction in which the blocking object appears. For example, when the blocking object appears from the direction of the driver seat, the determiner 130 determines that the state is the blocked state if the state in which the cumulative quantity of the feature points is less than the first threshold continues for less than the first set time. On the other hand, when the blocking object appears from the direction of the passenger seat, the determiner 130 determines that the state is the blocked state if the state in which the cumulative quantity of the feature points is less than the second threshold continues for less than the second set time. The determiner 130 can suppress a process in which the driver state determination is easily performed when the body of the occupant of the passenger seat has blocked the detection area by setting the second set time to a period of time longer than the first set time. For example, the occupant of the passenger seat may operate the navigation device for the first set time or more. In this case, the process in which the driver state determination is easily performed is suppressed.

Although the example in which the threshold and the set time are changed has been described above, the determiner 130 may change the set time in accordance with the direction in which the blocking object appears without changing the threshold.

### Others

When the navigation operation has been detected, the determiner 130 may determine that the state is the blocked state or may determine that the driver state determination will not be executed. The navigation operation is, for example, the operation described in FIG. 9. It is only necessary for the navigation operation to be an operation in the operation area AR such as the navigation HMI 52.

As described above, the determiner 130 can appropriately determine whether or not the detection area of the detection device is in the blocked state by determining that the detection area is in the blocked state or without performing the driver state determination when the navigation operation has been detected. For example, even if the index is not less than the threshold, when the operation on the navigation device has been detected, it is determined that the detection area is in the blocked state because there is a very high possibility that there is a blocking object, such that it is possible to prevent the driver state determination whose accuracy is likely to be low from being performed.

When the determiner 130 executes the driver state determination and determines that the driver is not in a drivable state for the vehicle M, the controller 140 may perform a process for controlling the vehicle M (assistance control). A state that is not the drivable state is, for example, while the vehicle M is traveling, a case where the posture of the driver is tilted forward or sideways by a predetermined degree or more, a case where the driver’s eyelids are closed for a predetermined period of time or more, or the like. It is only necessary for the state that is not the drivable state to be a case where it is determined that the driver cannot perform driving (control) of a steering operation or a speed operation of the vehicle M or the like.

The controller 140 may perform control for automatically decelerating the speed of the vehicle M or control for automatically stopping the vehicle M as assistance control. The assistance control is control for automatically and safely stopping the traveling of the vehicle M in accordance with a surrounding situation to ensure the safety of the occupants and surroundings of the vehicle M. The controller 140 executes assistance control in accordance with a surrounding situation recognized by the recognizer 110. The assistance control may include alert control. Through the alert, a notification indicating that the driver is not in the drivable state for the vehicle M, a notification indicating that the vehicle M is decelerated and stopped, or the like is provided to the occupant of the vehicle M or a nearby area.

As described above, the controller 140 can appropriately control the mobile object by executing assistance control when the driver is not in a drivable state for the vehicle M. For example, it is possible to determine that the driver is not in the drivable state for the vehicle M when the driver’s posture is tilted forward or sideways by a predetermined degree or more, and it is possible to ensure the safety of the occupants and surroundings of the vehicle M by decelerating and stopping the vehicle M in accordance with the surrounding situation through assistance control.

According to the above-described embodiment, the driving assistance device 100 determines whether the state is the blocked state based on the feature points. Thereby, it is possible to appropriately determine whether or not the in-cabin camera 18 is in a state in which the detection area of the detection device has been blocked.

The embodiment described above can be represented as follows.

A mobile object control device including:

a storage device storing a program; and

a hardware processor, the hardware processor executing the program stored in the storage device to:

acquire feature points of an occupant obtained from a detection result of a detection device configured to detect the occupant located in a mobile object;

determine whether or not a driver of the mobile object is in a drivable state for the mobile object based on the feature points;

determine that a detection area of the detection device is in a blocked state to prevent the driver state determination using the detection result indicating that the detection area is in the blocked state from being executed when an index based on the feature points is less than a threshold set in advance based on the feature points obtained from the detection result of the driver in the drivable state for the mobile object; and

determine that the detection area is not in the blocked state to execute the driver state determination using the detection result indicating that the detection area is not in the blocked state when the index based on the feature points is greater than or equal to the threshold set in advance.

Although modes for carrying out the present invention have been described using embodiments, the present invention is not limited to the embodiments and various modifications and substitutions can also be made without departing from the scope and spirit of the present invention.

What is claimed is:

1. A mobile object control device comprising:
a storage medium storing computer-readable instructions; and
one or more processors connected to the storage medium, the processor executing the computer-readable instructions to:
acquire feature points of an occupant obtained from a detection result of a detection device configured to detect the occupant located in a mobile object;
determine that a detection area of the detection device is in a blocked state to prevent driver state determination using the detection result indicating that the detection area is in the blocked state from being executed
when an index based on the feature points is less than a threshold set in advance based on the feature points obtained from the detection result of the driver in the drivable state for the mobile object; and
determine that the detection area is not in the blocked state to execute the driver state determination using the detection result indicating that the detection area is not in the blocked state when the index based on the feature points is greater than or equal to the threshold set in advance, wherein
the driver state determination for determining whether or not a driver of the mobile object is in a drivable state for the mobile object based on the feature points.

2. The mobile object control device according to claim 1, wherein
the processor executes the computer-readable instructions to:
determine a direction in which a blocking object for blocking the detection area appears based on the feature points; and
change the threshold in accordance with the direction.

3. The mobile object control device according to claim 2, wherein
the processor executes the computer-readable instructions to:
determine the blocked state by comparing the index based on the feature points with a first threshold when it is determined that the detection area is in the blocked state by the blocking object appearing from a direction of a driver seat of the mobile object; and
determine the blocked state by comparing the index based on the feature points with a second threshold less than the first threshold when it is determined that the detection area is in the blocked state by the blocking object appearing from a direction of a passenger seat of the mobile object.

4. The mobile object control device according to claim 2, wherein
the processor executes the computer-readable instructions to
determine the blocked state by comparing the index with the threshold, wherein
the index is a cumulative quantity of the feature points.

5. The mobile object control device according to claim 2, wherein
the processor executes the computer-readable instructions to determine that the detection area is in the blocked state when a state in which the index based on the feature points is less than the threshold set in advance continues for a set time or more.

6. The mobile object control device according to claim 5, wherein the processor executes the computer-readable instructions to:
set the set time to a first set time when it is determined that the detection area is in the blocked state by the blocking object appearing from a direction of a driver seat of the mobile object, and
set the set time to a second set time longer than the first set time when it is determined that the detection area is in the blocked state by the blocking object appearing from a direction of a passenger seat of the mobile object.

7. The mobile object control device according to claim 1,
wherein the detection device is provided in a navigation device of the mobile object or near the navigation device, and
wherein the processor executes the computer-readable instructions to prevent the determination of the blocked state or the driver state determination from being performed in a state in which an operation on the navigation device of the mobile object has been detected.

8. The mobile object control device according to claim 1, wherein
the processor executes the computer-readable instructions to decelerate or stop the mobile object when it is determined that the driver of the mobile object is not in the drivable state as determined in the driver state determination.

9. A mobile object control method comprising:
acquiring, by a computer, feature points of an occupant obtained from a detection result of a detection device configured to detect the occupant located in a mobile object;
determining, by the computer, that a detection area of the detection device is in a blocked state to prevent driver state determination using the detection result indicating that the detection area is in the blocked state from being executed when an index based on the feature points is less than a threshold set in advance based on the feature points obtained from the detection result of the driver in the drivable state for the mobile object; and
determining, by the computer, that the detection area is not in the blocked state to execute the driver state determination using the detection result indicating that the detection area is not in the blocked state when the index based on the feature points is greater than or equal to the threshold set in advance, wherein
the driver state determination for determining whether or not a driver of the mobile object is in a drivable state for the mobile object based on the feature points.

10. A non-transitory storage medium storing a program for causing a computer to execute:
a process for acquiring feature points of an occupant obtained from a detection result of a detection device configured to detect the occupant located in a mobile object;
a process for determining that a detection area of the detection device is in a blocked state to prevent the driver state determination using the detection result indicating that the detection area is in the blocked state from being executed when an index based on the feature points is less than a threshold set in advance based on the feature points obtained from the detection result of the driver in the drivable state for the mobile object; and
a process for determining that the detection area is not in the blocked state to execute the driver state determination using the detection result indicating that the detection area is not in the blocked state when the index based on the feature points is greater than or equal to the threshold set in advance, wherein
the driver state determination for determining whether or not a driver of the mobile object is in a drivable state for the mobile object based on the feature points.
